(19) United States
(12) Patent Application Publication
(10) Pub. No.: US 2024/0080801 A1
(43) Pub. Date: Mar. 7, 2024

(54) MAPPING OF PAGING EARLY INDICATOR TO MULTIPLE PAGING OCCASIONS

(71) Applicant: Telefonaktiebolaget LM Ericsson (PUBL), Stockholm (SE)

(72) Inventors: Niklas Andgart, SÖDRA SANDBY (SE); Ali Nader, MALMÖ (SE); Sina Maleki, MALMÖ (SE); Andres Reial, HÖLLVIKEN (SE); Ajit Nimbalker, DUBLIN, CA (US); Santhan Thangarasa, VÄLLINGBY (SE)

(21) Appl. No.: 18/261,312

(22) PCT Filed: Jan. 14, 2022
(86) PCT No.: PCT/EP2022/050807

§ 371 Date: Jul. 13, 2023

Related U.S. Application Data
(60) Provisional application No. 63/137,799, filed on Jan. 15, 2021.

(51) Int. Cl. H04W 68/02; H04W 68/00

(52) U.S. Cl. CPC H04W 68/02; H04W 68/005

(57) ABSTRACT

A method (1200) by a wireless device (110) includes receiving (1202), from a network node (160), a paging early indicator, PEI, configuration that includes an indication of a mapping of a PEI to a plurality of paging occasions, POs. The wireless device receives (1204) the PEI from the network node. Based on the mapping of the PEI to the plurality of POs, the wireless device monitors (1206) a shared channel during the plurality of POs.

### TECHNICAL FIELD

The present disclosure relates, in general, to wireless communications and, more particularly, systems and methods for mapping of paging early indicator (PEI) to multiple paging occasions (POs).

### BACKGROUND

A 5^{th} Generation (5G)/New Radio (NR) user equipment (UE) in RRC_IDLE and RRC_INACTIVE states operates in a so-called discontinuous reception (DRX) mode, which enables the UE to save power. During this mode, the UE occasionally wakes up according to a network (NW)-configured scheme and listens to a paging channel In case the NW is interested in reaching the UE, it pages the UE at these configured occasions and the UE establishes a connection to the NW. The paging message from the NW can be either initiated by the Core NW (CN) or the base station (e.g., gNB). More specifically, the CN-Initiated paging is used to reach the UEs in RRC_IDLE state, whereas the gNB-Initiated paging (aka Radio Access Node (RAN) paging) is used to reach UEs in RRC_INACTIVE state.

The paging message from the NW is carried out via a Physical Downlink Control Channel (PDCCH)/Physical Downlink Shared Channel (PDSCH) combination similar to other scheduled data in the downlink (DL). When the NW has DL data for a UE, it transmits, on the PDCCH, a Downlink Control Information (DCI) container with details about where and how the UE can find data in a PDSCH. Various formats of DCI exist in the 3GPP specifications. 3GPP TS 38.212 discusses that, for a paging message, a DCI format such as, for example, DCI format 1_0, may be used, and the generated Cyclic Redundancy Check (CRC) bits of the DCI are scrambled with a specific value called Paging-Radio Network Temporary Identifier (P-RNTI) (0XFFFE).

The NW typically configures several paging occasions per DRX cycle. For example, the NW may configure 8 Paging Occasions (POs) within a DRX cycle of 1.28 seconds. The paging configuration, which specifies the amount of POs and positions in time, is broadcast over the air in system information (SI) as part of SIB1 contents, for example. When a UE registers in the NW, it gets assigned a UE identity called 5G-Shortened-Temporary Mobile Subscriber Identity (5G-S-TMSI). This identity is used by the UE and NW in a formula specified by 3^{rd} Generation Partnership Project (3GPP) to derive in which of the configured occasions the UE will listen for a potential paging message. It shall be noted that several UEs could be listening for a potential paging message at the very same occasion (i.e., in the same PO). In case the UEs detect a paging DCI (i.e. DCI 1_0 with P-RNTI-scrambled CRC), the UEs have to look in the payload of PDSCH to see whether their identity is present and, thus, if the paging message was intended for them.

The payload of the PDSCH might carry up to 32 identities. Thus, up to 32 UEs may be paged during the same occasion. Even though a UE's 5G-S-TMSI ID is used in the formulas for deriving the occasion, the identity that the UE looks for inside the PDSCH may be of another type. For example, in case the UE is in RRC_IDLE state it looks for its 5G-S-TMSI (i.e. CN-Initiated paging message). However, if the UE is in RRC_INACTIVE state, the UE has to look for both for 5G-S-TMSI, and the RAN-assigned Inactive-Radio Network Temporary Identifier (I-RNTI) identity since a UE in RRC_INACTIVE state may be either paged by the CN or the RAN.

The contents of a 3GPP Rel-16 DL paging-related DCI format 1-0 (CRC scrambled by P-RNTI) used for scheduling of paging-related PDSCH is discussed in 3GPP TS 38.212 and includes the following:
Short Messages Indicator (2 bits)
Short Messages (8 bits). If only the scheduling information for Paging is carried, this bit field is reserved. Bits 4-8 are reserved for future use
Frequency domain resource assignment (variable bit length dependent on bandwidth (BW))—If only the short message is carried, this bit field is reserved.
Time domain resource assignment (4 bits). If only the short message is carried, this bit field is reserved.
Virtual Resource Block (VRB)-to-Physical Resource Block (PRB) mapping (1 bit). If only the short message is carried, this bit field is reserved.
Modulation and coding scheme (5 bits). If only the short message is carried, this bit field is reserved.
Transport Block (TB) scaling (2 bits). If only the short message is carried, this bit field is reserved.
Reserved bits −8 bits for operation in a cell with shared spectrum channel access; otherwise 6 bits
   Note that there exist several reserved bits for future usage.

In NR Rel-15, multiple synchronization signals (i.e., synchronization signal blocks (SSBs)) may be configured per cell, spatially covering different regions. The SSBs are transmitted in an SSB burst fashion. A typical SSB burst periodicity is 20 ms. For example, if only one SSB is transmitted in the cell (assumed for simplicity throughout the rest of the document), the same SSB is transmitted every 20 ms in the cell. FIG. 1 illustrates SSB transmissions for different Subcarrier Spacing (SCS).

Paging signaling (PDCCH and PDSCH) are specified to have a quasi-colocation relation with an SSB in a cell, meaning that a UE that receives an SSB with a certain receiver configuration can rely on that the same spatial RX configuration, and Timing/Frequency (T/F) offsets will be valid for paging reception. For a UE in NR, in order to be able to receive the paging signaling properly, channel estimates are typically carried out on the SSB(s) prior to the PO occasion. The number of SSBs required for channel estimation prior to PO reception depends on UE perceived coverage level, whether the reception is for PDCCH only or both PDCCH/PDSCH, the hardware architecture (e.g. number of Rx chains) and alike.

Each PO monitoring operation is associated with significant processing at the UE. Specifically, the UE must wake ahead of the PO time to obtain T/F synchronization for the paging PDCCH reception, then collect the PDCCH samples and perform tentative decoding. Depending on the Signal-Interference-to-Noise Ratio (SINR), the UE may need to use more than one SSB for loop convergence in preparation for potential paging PDSCH reception, making the T/F sync overhead quite large compared to the PO monitoring (i.e. PO PDCCH reception) itself.

To potentially reduce that overhead, a PEI signal may be used to indicate to the UE whether paging signaling (PDCCH/PDSCH) is expected in an upcoming PO. If there is no paging signals to receive and, thus, the PEI does not indicate a need to monitor the PO, the UE may skip high-quality loop convergence efforts and instead go to deep sleep state (low power consuming state). If, on the other hand, the PEI indicates that a paging PDCCH/PDSCH is expected, the UE will prepare for possible PDSCH reception and monitor the PDCCH to find out whether it is being targeted.

In an exemplary implementation, the UE regularly decodes/searches for PEI at preconfigured occasions. In case there is imminent data to be scheduled for the UE by the NW, a PEI (which may also be referred to as Wake Up Signal (WUS)) is transmitted by the NW. Based on the PEI, the UE knows that it shall wake up, prepare itself for reception (perform channel estimate), and receive a potential message at specified occasion. FIG. 2 illustrates PEI signals being transmitted by the NW in addition to existing paging-related transmission. Specifically, FIG. 2 illustrates transmitting PEI at extra occasions prior to data scheduling.

Certain problems exist, however. For example, PEI transmission is an additional cost for the NW/gNB in idle mode, in terms of resources not available for data transmission, and due to the need to wake up from sleep states to perform additional transmissions. Additionally, some UEs may operate with traffic types that lead to a large number of PEI transmissions. There may also be cases where the NW regularly needs to go active only to transmit PEI. Further, in 3GPP discussions, the PEI is considered as a one-to-one mapping, i.e., one PEI per PO. This, in turn, means the NW has to send one additional signal in idle mode for each PO, leading to a large NW overhead and power consumption.

Accordingly, there is a need for methods to configure to limit the number of PEI transmissions.

### SUMMARY

Certain aspects of the present disclosure and their embodiments may provide solutions to these or other challenges. For example, certain embodiments provide a one-to-many PEI mapping such that the PEI instructs a UE or group of UEs to monitor paging in a number of consecutive POs. Additionally or alternatively, certain embodiments enable the same PEI to target several UEs with potentially different POs.

According to certain embodiments, a method by a wireless device includes receiving, from a network node, a PEI configuration that includes an indication of a mapping of a PEI to a plurality of paging occasions. The wireless device receives, from the network node, the PEI. Based on the mapping of the PEI to the plurality of paging occasions, the wireless device monitors a shared channel during the plurality of paging occasions.

According to certain embodiments, a wireless device is adapted to receive, from a network node, a PEI configuration that includes an indication of a mapping of a PEI to a plurality of paging occasions. The wireless device is adapted to receive, from the network node, the PEI. Based on the mapping of the PEI to the plurality of paging occasions, the wireless device is adapted to monitor a shared channel during the plurality of paging occasions.

According to certain embodiments, a wireless device includes a memory storing instructions and a processor operable to execute the instructions to cause the wireless device to receive, from a network node, a PEI configuration that includes an indication of a mapping of a PEI to a plurality of paging occasions. The processor is further operable to receive, from the network node, the PEI and, based on the mapping of the PEI to the plurality of paging occasions, monitor a shared channel during the plurality of paging occasions.

According to certain embodiments, a method by a network node includes transmitting, to at least one wireless device, a PEI configuration that includes an indication of a mapping of a first PEI to a plurality of paging occasions. Based on the mapping, the network node transmits the PEI to the at least one wireless device to trigger monitoring of a shared channel during the plurality of paging occasions by the at least one wireless device.

According to certain embodiments, a network node is adapted to transmit, to at least one wireless device, a PEI configuration that includes an indication of a mapping of a first PEI to a plurality of paging occasions. Based on the mapping, the network node is adapted to transmit the PEI to the at least one wireless device to trigger monitoring of a shared channel during the plurality of paging occasions by the at least one wireless device.

According to certain embodiments, a network node includes a memory storing instructions and a processor operable to execute the instructions to cause the network node to transmit, to at least one wireless device, a PEI configuration that includes an indication of a mapping of a first PEI to a plurality of paging occasions. Based on the mapping, the processor is adapted to transmit the PEI to the at least one wireless device to trigger monitoring of a shared channel during the plurality of paging occasions by the at least one wireless device.

Certain embodiments may provide one or more of the following technical advantages. For example, one technical advantage may be that certain embodiments decrease PEI overhead, freeing up resources for data transmission or improving NW energy efficiency by remaining longer in sleep state, where an individual PEI transmission instructs the UE to monitor several consecutive POs, or where several POs are associated to the same PEI. As another example, a technical advantage may be that certain embodiments use NW implementation guidelines for selecting appropriate one-to-many mapping configurations base on NW performance, UE performance, NW energy efficiency (EE), and UE EE considerations, as well as ensuring PEI transmission robustness.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates SSB transmissions for different SCS;

FIG. 2 illustrates PEI signals being transmitted by the NW in addition to existing paging-related transmission;

FIG. 3 illustrates a single PEI waking up multiple UEs with different POs, according to certain embodiments;

FIG. 4 illustrates an example PEI DCI mapping with one PEI being mapping to many POs, according to certain embodiments;

FIG. 5 illustrates an example high-level logical flow of an example scenario where a network node signals a single PEI for multiple POs, according to embodiments;

FIG. 6 illustrates an example scenario where a network node utilizes the PDCCH of PO assigned to a first UE (UE1) to convey PEI for the PO assigned to a second UE (UE2), according to certain embodiments;

FIG. 7 illustrates the corresponding example high-level logical flow of an example scenario where a UE receives a single PEI for multiple POs, according to embodiments;

FIG. 8 illustrates an example wireless network, according to certain embodiments;

FIG. 9 illustrates an example network node, according to certain embodiments;

FIG. 10 illustrates an example wireless device, according to certain embodiments;

FIG. 11 illustrate an example user equipment, according to certain embodiments;

FIG. 12 illustrates a virtualization environment in which functions implemented by some embodiments may be virtualized, according to certain embodiments;

FIG. 13 illustrates a telecommunication network connected via an intermediate network to a host computer, according to certain embodiments;

FIG. 14 illustrates a generalized block diagram of a host computer communicating via a base station with a user equipment over a partially wireless connection, according to certain embodiments;

FIG. 15 illustrates a method implemented in a communication system, according to one embodiment;

FIG. 16 illustrates another method implemented in a communication system, according to one embodiment;

FIG. 17 illustrates another method implemented in a communication system, according to one embodiment;

FIG. 18 illustrates another method implemented in a communication system, according to one embodiment;

FIG. 19 illustrates an example method by a wireless device, according to certain embodiments;

FIG. 20 illustrates an exemplary virtual computing device, according to certain embodiments;

FIG. 21 illustrates another example method by a wireless device, according to certain embodiments;

FIG. 22 illustrates an example method by a network node, according to certain embodiments;

FIG. 23 illustrates another exemplary virtual computing device, according to certain embodiments; and

FIG. 24 illustrates another example method by a network node, according to certain embodiments.

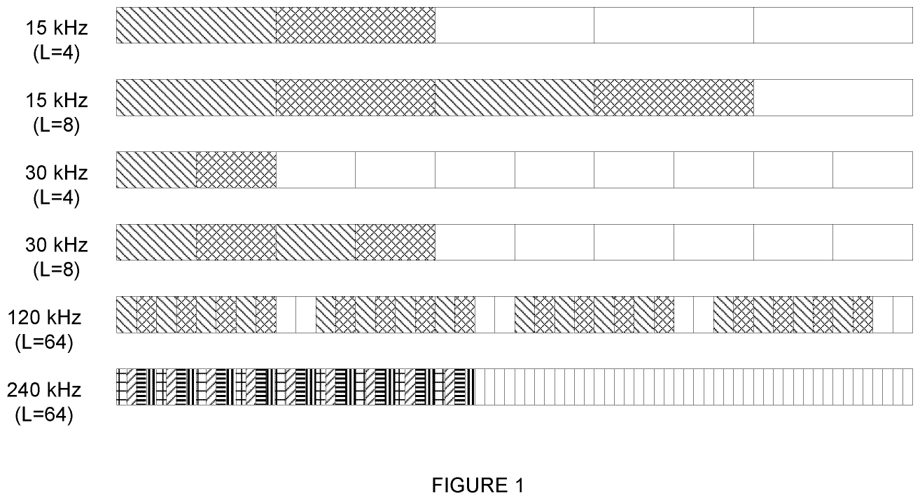

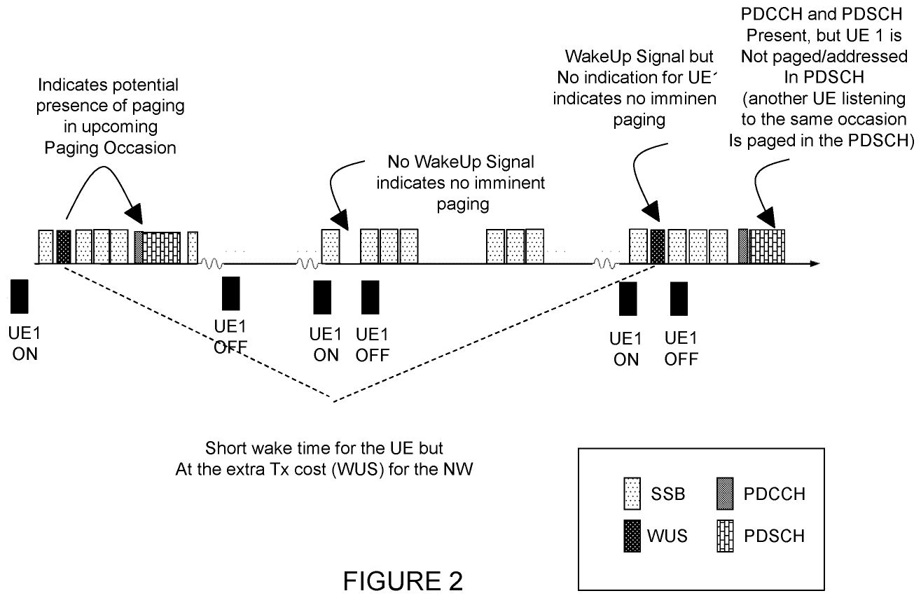

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, Master eNodeB (MeNB), a network node belonging to Master Cell Group (MCG) or Secondary Cell Group (SCG), base station (BS), multi-standard radio (MSR) radio node such as MSR BS, eNodeB (eNB), gNodeB (gNB), network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operation and Maintenance (O&M), Operations Support System (OSS), Self Organizing Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, Personal Digital Assistant (PDA), Tablet, mobile terminals, smart phone, laptop embedded equipped (LEE), laptop mounted equipment (LME), Unified Serial Bus (USB) dongles, UE category M1, UE category M2, Proximity Services UE (ProSe UE), Vehicle-to-Vehicle UE (V2V UE), Vehicle-to-Anything (V2X UE), etc.

Additionally, terminologies such as BS/gNB and UE should be considered non-limiting and do in particular not imply a certain hierarchical relation between the two; in general, gNB could be considered as device 1 and UE could be considered as device 2 and these two devices communicate with each other over some radio channel. Further, the transmitter or receiver could be either gNB, or UE.

Note that throughout the document, the term idle/IDLE is used to refer to both RRC_IDLE and RRC_INACTIVE states.

According to certain embodiments, the NW may provide configuration of PEI to the UEs within a cell, or a group of cells such as, for example, through a system information block (SIB) based on a paging configuration. Furthermore, according to certain embodiments, the NW may have the option to configure PEI for one-to-one (i.e., one PEI per PO) or one-to-many (i.e., one PEI for multiple POs). However, the focus of this disclosure is on the latter, i.e., when the PEI is configured to have a one-to-many mapping and, thus, one PEI refers to multiple PO, instead of the baseline one-to-one mapping between PEI and PO. According to certain embodiments, systems, methods, techniques, and mechanisms are disclosed for enabling the NW to configure one-to-many options and transmit PEI associated with multiple POs.

Furthermore, the systems, methods, and techniques disclosed herein can, unless it is explicitly mentioned, be applicable to any type of PEI, e.g., DCI-based, or sequence-based, e.g., SSB- or Tracking Reference Signal (TRS)-based.

Single PEI from NW Waking Up Multiple POs for Different UEs

According to certain embodiments, multiple UEs monitoring different POs may be configured to monitor the same PEI. As a result, PEI may need to be transmitted less frequently as compared to the case where one PEI is transmitted per PO. From the NW side, this can be seen as a one-to-many mapping in that one PEI addresses multiple POs monitored by different UEs. However, from the UE perspective, this can be still regarded as a one-to-one PEI, still referring to a single PO. In other words, the one to many configuration may be transparent to the UE, in certain embodiments.

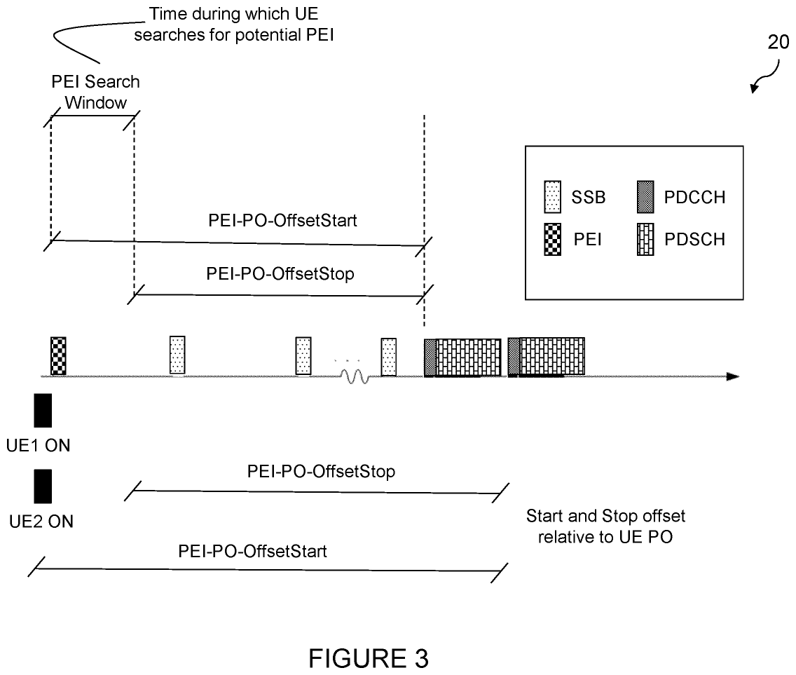

FIG. 3 illustrates an example scenario 20 for using a single PEI to wakeup multiple UEs with different POs, according to certain embodiments. More specifically, FIG. 3 depicts two UEs that are configured with different POs. Each UE is configured with a PEI Search Window (i.e., potential PEI monitoring occasions). In a particular embodiment, the PEI Search Window may be defined by Pei-PO-OffsetStart and Pei-PO-OffsetStop. However, such start/stop offsets are only exemplary and other options may be introduced for defining the PEI search window.

According to certain embodiments, the UE monitors PEI in the region of the PEI Search Window and, if PEI is detected indicating there is a paging message (e.g. intended for the UE), the UE knows to wake up for the corresponding PO and monitor paging.

In order for the two UEs with different positions of the POs to be able to share the same PEI, the configuration can be carried out using individual configurations, a reference PO, and/or UE grouping.

For example, where individually configured, the UEs/POs associated with a PEI are configured with different Start and Stop Offsets, such that the resulting PEI search windows overlap in part or completely, in a particular embodiment. This requires individual PEI search window configurations corresponding to the different POs.

As another example, where a reference PO is used, the UEs/POs associated with a PEI may, in addition to being configured with POs, also each be configured with reference time point, in a particular embodiment.

Example of such reference point could be a specific System Frame Number (SFN), or this reference point could be a reference PO, as illustrated in FIG. 3. The PEI search window configuration then specifies start and stop offsets in relation to this reference PO, and the UE then knows that, if PEI is found, it should wake up to monitor paging in its own PO on or as soon as possible after the reference PO. As such, in this approach, a group of POs can be associated with the same PEI considering their PEI search window is the same, and thus any PEI received within the search window can be considered as indication for multiple POs.

In another particular embodiment, the reference PO may be considered as the starting point for PEI applicability, i.e., PEI configuration is applicable from the reference PO. As such in one approach, PEI configuration may entail one parameter defining if PEI is applicable to one or more POs (if multiple POs, then it means multiple consecutive POs). For example, the parameter can be configured e.g., as any integer in the range 1, . . . , 10. For example, if the parameter indicates value of 3, it means each PEI is associated to three consecutive POs. Therefore, in this scenario, when the UE knows reference PO as starting PO and also knows the one to many parameter, then the UE knows how each received PEI is associated with different multiple of POs. For example, the NW may transmit a first PEI and a second PEI, where the first PEI is associated to the first three POs (assuming the one to many parameter is configured as 3) after or including reference PO, and the second PEI to the next three POs.

In a particular embodiment, the NW can configure N paging occasions per DRX cycle or a reference duration (e.g. one SFN cycle, 1.024 seconds, 1.28 seconds). The NW can configure a parameter M via higher layer configuration to indicate that a single PEI is associated with M consecutive POs. For example, if N=128 POs are configured and M=4, a first PEI is associated with POs 0,1,2,3, and second PEI is associated with POs 4,5,6,7, and so on.

In a particular embodiment, the PEI may be linked to a reference PO and indicate the need to monitor any POs from the current reference PO the next reference PO. This is equivalent to configuring the integer above to be equal to the number of POs between adjacent reference POs, but not using an explicit parameter.

As different UEs may have different DRX periodicity, the reference PO may be configured with a DRX offset that is different from the UE DRX period. In case the DRX periodicity of the reference PO (e.g. 256 ms) is shorter than the UE DRX periodicity (e.g. 1.28 seconds), the UE may ignore a reference PO where it has no corresponding PO and use the reference PO closest to its configured PO. Using the example reference=256 ms and DRX periodicity of 1.28 s, the UE has 4 reference POs for each PO, and the UE selects one of these reference POs to monitor since the UE can only use its configured PO and the UE needs to exclude additional ones without match.

Conversely, in case the reference periodicity is longer than the UE DRX periodicity and there is no reference PO corresponding to a UE PO, the UE may, in a particular embodiment, continue to sleep without monitoring paging. In another embodiment, the UE may, as reference, use its own configured PO. In still another embodiment, the UE may use the closest reference PO preceding its own configured PO. And, in yet another embodiment, the UE may directly monitor the PO without waiting for PEI.

As still another example, where UE grouping is used to carry out the configuration, a group of UEs configured to use multiple POs (e.g. different UEs in the group are mapped to different POs) are configured with the same PEI configuration, according to certain embodiments.

In a particular embodiment, PEI indication of availability of paging is applicable to all the associated POs. For example, if UE1 is in PO1 and UE2 in PO2 but both of them receive the same PEI and PEI indicates there is a paging, then both UEs have to monitor paging in PO1 and PO2.

In another particular embodiment, if PEI is DCI based, the PEI payload may include a bitfield indicating which of the associated POs include paging (e.g., a pei-poMapping field). The bitfield can be configured as part of PEI configuration, or pre-configured such as, for example, as part of standardization specifications. For example, if one to many PEI is configured through one to many parameter in PEI configuration as described above, and the parameter is larger than 1, the UE automatically can assume a potential bitfield indicating the presence of the paging is increased by one bit for example. In this case, each bit can be used as indication of which of the POs include a paging message, for example.

In a particular embodiment, the number of POs K to which the PEI maps may exceed the number of bits in the bitfield, L. Then each bit may indicate the presence of paging in multiple POs, e.g. K/L POs. The multiple POs may be adjacent/sequential or the sets may be interleaved (one set includes every L-th PO, with set-specific offsets), in various embodiments.

In a particular embodiment, PEI indication of availability of paging is applicable to all the associated PO. For example, if UE1 is in PO1 and UE2 in PO2, but both of the UEs receive the same PEI and the PEI indicates there is a paging, then both UEs have to monitor paging in their respective POs. Specifically, UE1 monitors PO1 and UE2 monitors PO2.

In another embodiment, if PEI is DCI-based, the PEI payload may include a bitfield indicating which of the associated POs include paging and, optionally, for which subgroup of UEs within a particular PO the paging is intended. The bitfield can be configured as part of PEI configuration. Alternatively, the bitfield can be pre-configured as part of standardization specifications. For example, if one-to-many PEI is configured through one-to-many parameter in PEI configuration as described above, and the parameter is larger than 1, the UE automatically can assume a potential bitfield indicating the presence of the paging is increased by one bit. For example, the DCI may contain M bits bitfield, one for each of the M POs associated with the PEI. In this case, each bit can be used as an indication of which of the POs include a paging message.

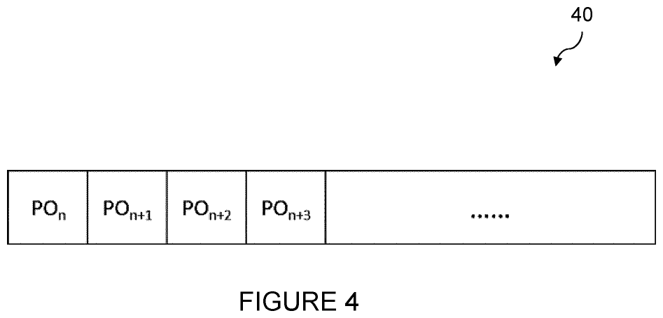

FIG. 4 illustrates an example PEI DCI mapping 40 with one PEI being mapping to many POs, according to certain embodiments. More specifically, FIG. 4 depicts an example DCI where a single PEI DCI includes indication for four paging occasions (denoted by PO with subscripts n, n+1, n+2, n+3), with one field per each paging occasion. For each Paging occasion, the field size can be one or larger, depending on the number of subgroups configured for the corresponding paging occasion.

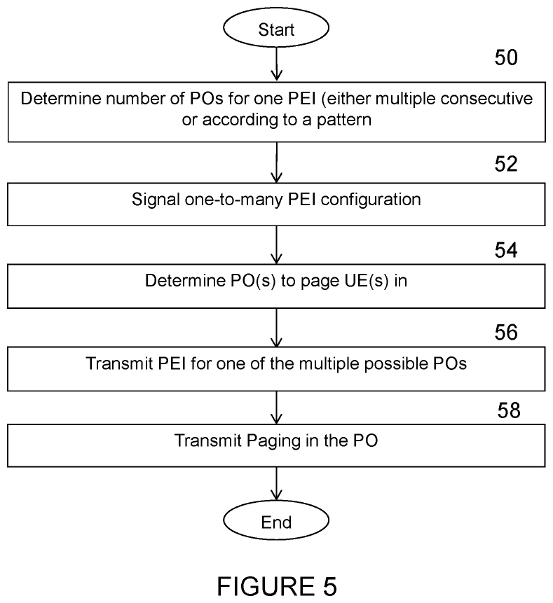

In case PEI is sequence-based, e.g., SSB- or TRS-based, a first sequence may indicate that all the associated POs should be monitored for paging (or vice versa if the indication means lack of paging), while a second sequence may indicate the first associated POs may include paging, and a third sequence may indicate the second associated POs may include paging, and so on. The combination is also possible. For example, a fourth sequence may indicate that the first and second POs may include paging, while a fifth sequence may indicate only the third associated PO includes paging, and so on. The sequences may be different at least in one detectable characteristic, e.g., different scrambling code, sequence generator, time or frequency allocation, etc. Furthermore, the sequences may be configured through higher layer signaling, or pre-configured, e.g., as part of standardization documentations. FIG. 5 illustrates an example high-level logical flow of an example scenario where a network node signals a single PEI for multiple POs, according to embodiments. In step 50, the number of POs related to a PEI is determined. By using a large number POs, the PEI overhead will be limited, but the UE needs to wake up more often to monitor paging, particularly if the PEI indication of paging is applicable to all, and the PEI does not entail individual level indication of paging a large number of POs associated with a PEI may also lead to a loss in throughput by additional latency. For example, the NW may indicate there is no paging for the next 10 POs, and then an information comes in between, this can lead to NW needing to wait for the next DRX to transmit paging.

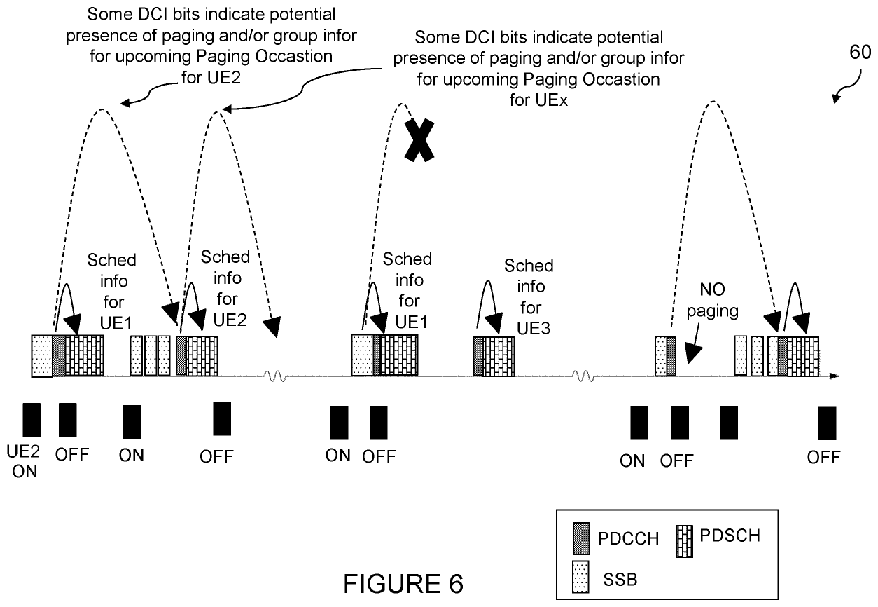

The number of consecutive paging occasions to refer to can be dependent on various criteria:
In some embodiment(s), it is based on previous knowledge or measurements of the particular UEs traffic. This may include traffic patterns, the acceptable delay, etc..
It may also be dependent on how many UEs share the same paging occasion and PEI configuration; in case one PEI can only address a limited number of UEs, and the number of simultaneous PEI transmission should be limited, a one-to-many mapping can be used which will make it possible for the same PO to be addressed by more than one PEI occasion.
In another embodiment, PEI is provided for one UE at the same occasions as the POs relevant for other UEs. FIG. 6 illustrates a scenario 60 where a network node utilizes the PDCCH of PO assigned to UE1 to convey PEI for the PO assigned to UE2. As a result, the network node is utilizing the already existing transmissions to convey the PEI for a UE. The only occasions when the network node has to transmit the PEI as an extra transmission are when no UE is paged at all at a certain PO, see last occasion on timeline of FIG. 6. Previous or other techniques may use the currently reserved bits of the paging DCI (DCI 1-0 with CRC scrambled with P-RNTI). If a one-to-many mapping is used, in some cases the extra PEI transmission without simultaneous paging can be avoided.
In order to determine the number of POs, in another approach or along with the previous ones, the network node may take the average paging rate of each PO into account, and then choose the number of POs such that the overall paging rate of the multiple POs remain below a threshold. E.g., the individual average paging rate of a PO may be 10%, and the network node would like to keep the overall paging rate of multiple POs associated with the same PEI below 50%, and thus up to 6 POs can be associated to the same PEI.
The number of multiple POs mapping to the same PEI may further be based on the false paging impact. Increasing the number of POs leads to increased false paging. In general, if the single-PO false paging rate is above a threshold (e.g. above 75%), the further increase due to combining multiple POs may then be inconsequential for UE EE, The network node may also consider that the effective false paging increase is a combined effect of multiple POs and the resolution of the PEI bitmap described above.
The choice of the number of POs mapping to one PEI, and alternatively their pattern (consecutive, interleaved, etc.) may be based on a joint consideration of the PEI transmission resource overhead at the network node, PEI transmission impact of NW EE; UE false paging impact on UE EE, and PEI monitoring impact on UE EE, based on model-based estimates or measured and reported EE performance.

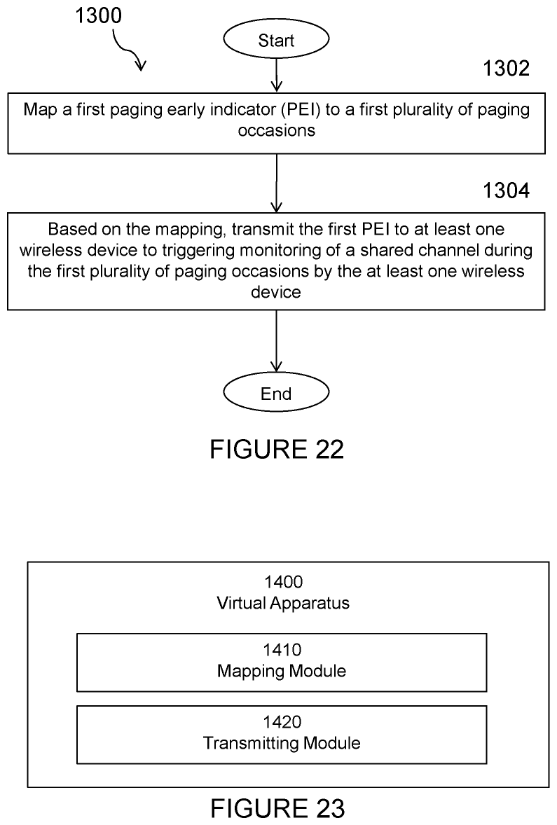

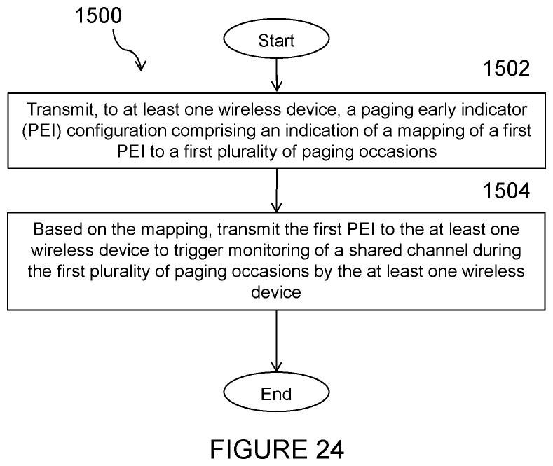

Returning to FIG. 5, the network node signals a one-to-many PEI configuration to the UE, at step 52. The network node may determine the PO(s) in which to page the UE, at step 54. At step 56, the network node transmits, to the UE, PEI for one of the multiple possible POs. The paging is transmitted to the UE in the PO, at step 58. More detailed example embodiments for these steps are discussed below with regard to at least FIGS. 22 and 24.

According to certain embodiments, the network node may provide a PEI configuration, e.g., using higher layer signaling such as SI broadcast. Thereby, UEs can receive the PEI configuration, monitor PEI and if indicated that there is a paging message, monitor the associated PO. The PEI can be either based on a DCI (i.e., indication of PEI is conveyed through a DCI) or based on a sequence, such as a RS, e.g., SSB or TRS like sequences.

The PEI configuration may be communicated as a PEI-Config in System information and may be relevant to one or more indicated BWPs.

In a particular embodiment, for example, a field pei-OneToManyRelation is added to the PEI-config, as shown in Table 1. The added field describes a number of consecutive POs the UE should monitor upon receiving the PEI. If the field is present, there is a one-to-many relation between PEI and PO. For example, one PEI indicating Paging means that UE has to receive PDCCH/PDSCH in n upcoming DRX cycles. The field may have a set of predefined values such as, for example, 2, 4 or 8 consecutive DRX cycles. If not present, the default one-to-one relation between PEI and PO PDCCH/PDSCHs is valid. Thus, one PEI indicating Paging means that the UE prepares for one corresponding PO PDCCH/PDSCH reception.

TABLE 1

| IE name | | | |
|---|---|---|---|
| (exemplary ASN.1 | Type/Range | | |
| name) | (Exemplary) | optional | Description/comment |
| pei- | ENUMERATED | Y | If not present, there is a one-to-one |
| OneToManyRelation | {n2, n4, n8} | | relation between PEI and PO |
| | | | PDCCH/PDSCHs. I.e., one PEI |
| | | | indicating Paging means that the UE |
| | | | prepares for one corresponding PO |
| | | | PDCCH/PDSCH reception. |
| | | | If present, there is a one-to-many |
| | | | relation between PEI and PO. I.e., one |
| | | | PEI indicating Paging means that UE |
| | | | has to receive PDCCH/PDSCH in n |
| | | | upcoming DRX cycles. |

In another particular embodiment, the set of POs to monitor is non-consecutive, e.g. reception of PEI instructs to monitor every n-th PO in a sequence of m paging occasions (i.e. total of m/n POs monitored). Alternatively, the configuration may indicate to monitor every n-th PO for a total of m paging occasions (i.e. total of m POs monitored).

In another particular embodiment, the field pei-OneToManyRelation is added to the PEI-config with a different interpretation (or using a separate field with another name) as shown in Table 2. It carries information about PEI grouping as discussed above, e.g.:

TABLE 2

| IE name | | | |
|---|---|---|---|
| (exemplary ASN.1 | Type/Range | | |
| name) | (Exemplary) | optional | Description/comment |
| pei- | ENUMERATED | Y | If not present, there is a one-to-one |
| OneToManyRelation | {n2, n4, n8} | | relation between PEI and PO |
| | | | PDCCH/PDSCHs. I.e., one PEI |
| | | | indicating Paging means that the UE |
| | | | prepares for one corresponding PO |
| | | | PDCCH/PDSCH reception. |
| | | | If present, PEI includes a bitmap of |
| | | | length n to indicate that the PEI |
| | | | applies to upcoming n POs and |
| | | | indicates which of the n POs contain |
| | | | paging messages and should be |
| | | | monitored. |

Alternatively, if the number of POs indicated by the PEI does not equal the number of bits in the bitmap, the two parameters may be provided separately, in a particular embodiment. (Mapping principles in those cases are discussed above.)

The mapping of UEs to POs may not be affected. A UE uses its legacy PO and the bit in the bitmap related to that PO determine its paging status.

In another embodiment, the PEI payload includes a bit indicating whether the PEI is a one-to-one or one-to-many PEI, or the PEI configuration includes such a bit, or the PEI configuration includes whether the indicator bit in the PEI payload is present.

In another particular embodiment, the PEI configuration includes a bitmap format definition for indicating individual POs or PO subsets to which the PEI applies. The bitmap format may specify the length of the bitmap, how a bit in the bitmap relates to the POs it indicates (individual, consecutive group, interleaved group, etc.)

In another particular embodiment, the PEI payload includes a pei-poMapping parameter including one or multiple bits indicating which PO the PEI refers to, e.g. using bitmaps or defining the number of consecutive POs.

In case several UEs share the same PEI, the different UEs may, by configuration of different PEI-Configs, interpret the PEI differently, in a particular embodiment. E.g. one UE may interpret the PEI as a one-to-one mapping, while other UEs may interpret it as a one-to-many mapping, with possibly different numbers of POs.

In a particular embodiment, if the UE is configured with a PEI referring to n POs, and no PEI is found, then the UE knows that no paging will occur in any of these POs, and can continue sleep for this whole period. In another embodiment, the UE is supposed to again monitor already the next PEI window. Variants between these options can exist, e.g. to have PEI referring to 4 consecutive PO, but monitor only PEI before every 2^{nd} PO.

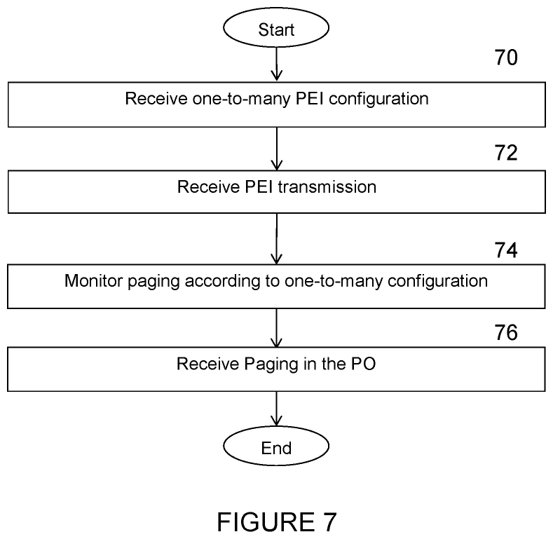

FIG. 7 illustrates the corresponding example high-level logical flow of an example scenario where the UE receives a single PEI for multiple POs, according to embodiments. For example, at step 70, the UE receives the one-to-many PEI configuration. At step 72, the UE receives the PEI transmission. At step 74, the UE monitors paging according to the one-to-many PEI configuration, and the UE receives paging in the PO, at step 76.

According to certain embodiments, different and various criteria may be used by the UE for applying the PEI configuration that is associated with multiple POs, i.e. one PEI referring to multiple PO occasions. As previously described, the one-to-many PEI indication (e.g. 1×N) allows the UE to stay in inactive state (e.g. DRX OFF or deep sleep) over multiple DRX cycles or POs if the received PEI indicates that the UE is not expected to receive any paging over the N DRX cycles or POs. The criteria for applying the said one-to-many PEI indication may include:
Information related to whether the UE has been paged over last time duration, T1;
   For example, it may be assumed that if the UE has been paged once then there is a probability that the same UE might be paged again in the coming POs. Therefore, it may be advantageous for the UE to not apply the one-to-many PEI indication directly, which may lead to UE skipping the coming POs and entering a deep sleep mode, instead the UE shall monitor the paging messages according to the legacy procedure such as, for example, in every PO. The parameter T1 can be expressed in terms DRX cycles and/or POs and can be either configured by the NW or predefined in the specification.
Information related to UE switching the RRC states over last time duration T2
   For example, it may be assumed that if the UE has been switched from the RRC CONNECTED state to RRC_IDLE/INACTIVE states over the last time duration, T2, then UE shall not apply the one-to-many PEI configuration directly. Instead, the UE shall monitor the paging according to the legacy behavior that requires the UE to monitor PO in every PO occasion. The motivation for not applying the one-to-many PEI indication directly is that there is high likelihood that the same UE is being scheduled again, and therefore it is advantageous for the UE to continue to monitor the paging in every PO occasion instead of monitoring the PO in the more relaxed manner. The parameter T2 can be expressed in terms DRX cycles, POs and can be either configured by the NW or predefined in the specification.
Information related to whether UE has performed any cell change
   For example, the UE may not apply the one-to-many PEI configuration directly after a cell change (e.g. cell re-selection, handover), e.g. within time duration T3. The motivation is that the cell change could be an indication that the UE is a high mobility UE meaning that it might perform a cell change again within certain time and therefore the UE should avoid monitoring the paging in a relaxed manner following one-to-many PEI at least for a certain time duration T3. The values of T3 can be configured by the NW or predefined in the specification.

As the effect of a missed PEI will be larger if the PEI was referring to multiple POs, a one-to-many PEI may need to be more reliable than a one-to-one PEI, according to certain embodiments. This may be accomplished, for example, by using a lower code rate (higher AL or smaller DCI size) for DCI-based PEI, or having a more robust sequence for sequence-based PEI, or in both cases increasing the transmitted PEI power.

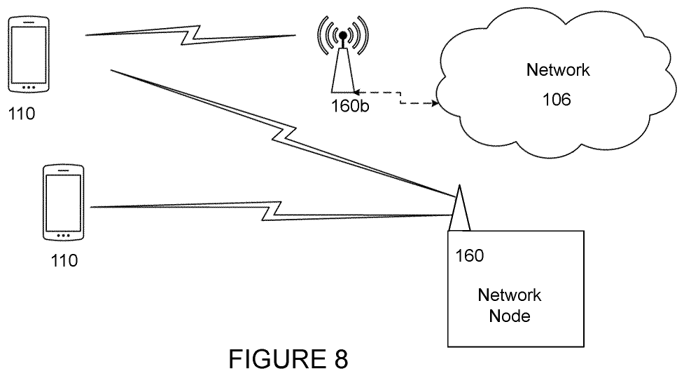

FIG. 8 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 8. For simplicity, the wireless network of FIG. 8 only depicts network 106, network nodes 160 and 160b, and wireless devices 110. In practice, a wireless network may further include any additional elements suitable to support communication between wireless devices or between a wireless device and another communication device, such as a landline telephone, a service provider, or any other network node or end device. Of the illustrated components, network node 160 and wireless device 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and wireless device 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

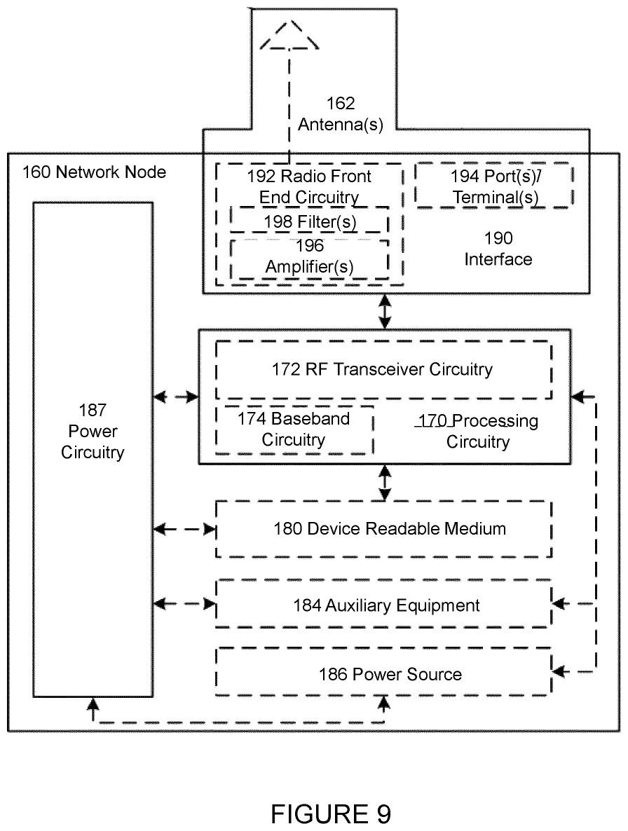

FIG. 9 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 9, network node 160 includes processing circuitry 170, device readable medium 180, interface 190, auxiliary equipment 184, power source 186, power circuitry 187, and antenna 162. Although network node 160 illustrated in the example wireless network of FIG. 9 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination. According to certain embodiments, processing circuitry 170 is configured to perform any of the steps and operations described below with respect to FIGS. 22 and 24.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or wireless devices 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or wireless devices via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 9 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

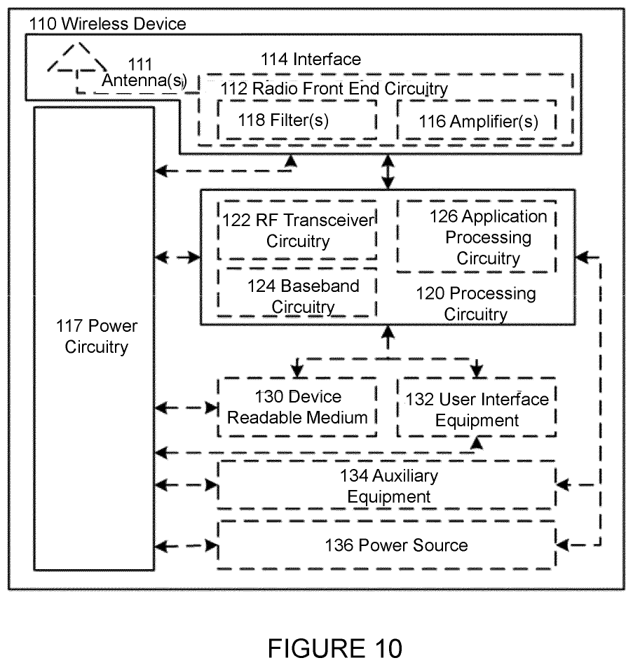

FIG. 10 illustrates an example wireless device 110. According to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. Wireless device 110 may include multiple sets of one or more of the illustrated components for different wireless technologies supported by wireless device 110, such as, for example, GSM, WCDMA, LTE, NR, WiFi, WiMAX, or Bluetooth wireless technologies, just to mention a few. These wireless technologies may be integrated into the same or different chips or set of chips as other components within wireless device 110.

Antenna 111 may include one or more antennas or antenna arrays, configured to send and/or receive wireless signals, and is connected to interface 114. In certain alternative embodiments, antenna 111 may be separate from wireless device 110 and be connectable to wireless device 110 through an interface or port. Antenna 111, interface 114, and/or processing circuitry 120 may be configured to perform any receiving or transmitting operations described herein as being performed by a wireless device. Any information, data and/or signals may be received from a network node and/or another wireless device. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, wireless device 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or wireless devices via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

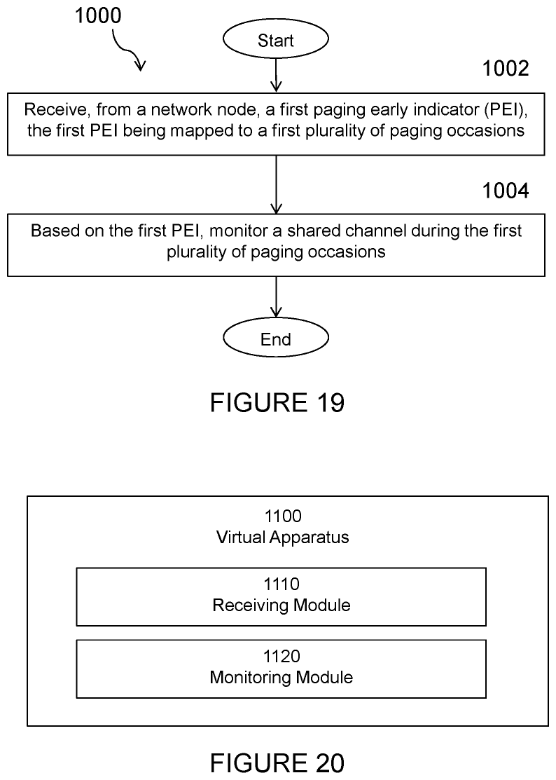

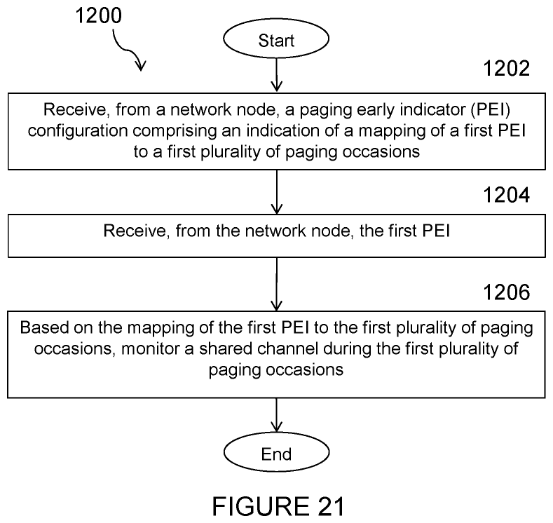

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 110 components, such as device readable medium 130, wireless device 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein. According to certain embodiments, processing circuitry 120 is configured to perform any of the steps and operations described below with respect to FIGS. 19 and 21.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of wireless device 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a wireless device may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of wireless device 110, but are enjoyed by wireless device 110 as a whole, and/or by end users and the wireless network generally.

Processing circuitry 120 may be configured to perform any determining, calculating, or similar operations (e.g., certain obtaining operations) described herein as being performed by a wireless device. These operations, as performed by processing circuitry 120, may include processing information obtained by processing circuitry 120 by, for example, converting the obtained information into other information, comparing the obtained information or converted information to information stored by wireless device 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with wireless device 110. Such interaction may be of many forms, such as visual, audial, tactile, etc. User interface equipment 132 may be operable to produce output to the user and to allow the user to provide input to wireless device 110. The type of interaction may vary depending on the type of user interface equipment 132 installed in wireless device 110. For example, if wireless device 110 is a smart phone, the interaction may be via a touch screen; if wireless device 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into wireless device 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from wireless device 110, and to allow processing circuitry 120 to output information from wireless device 110. User interface equipment 132 may include, for example, a speaker, a display, vibrating circuitry, a USB port, a headphone interface, or other output circuitry. Using one or more input and output interfaces, devices, and circuits, of user interface equipment 132, wireless device 110 may communicate with end users and/or the wireless network and allow them to benefit from the functionality described herein.

Auxiliary equipment 134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. wireless device 110 may further comprise power circuitry 137 for delivering power from power source 136 to the various parts of wireless device 110 which need power from power source 136 to carry out any functionality described or indicated herein. Power circuitry 137 may in certain embodiments comprise power management circuitry. Power circuitry 137 may additionally or alternatively be operable to receive power from an external power source; in which case wireless device 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of wireless device 110 to which power is supplied.

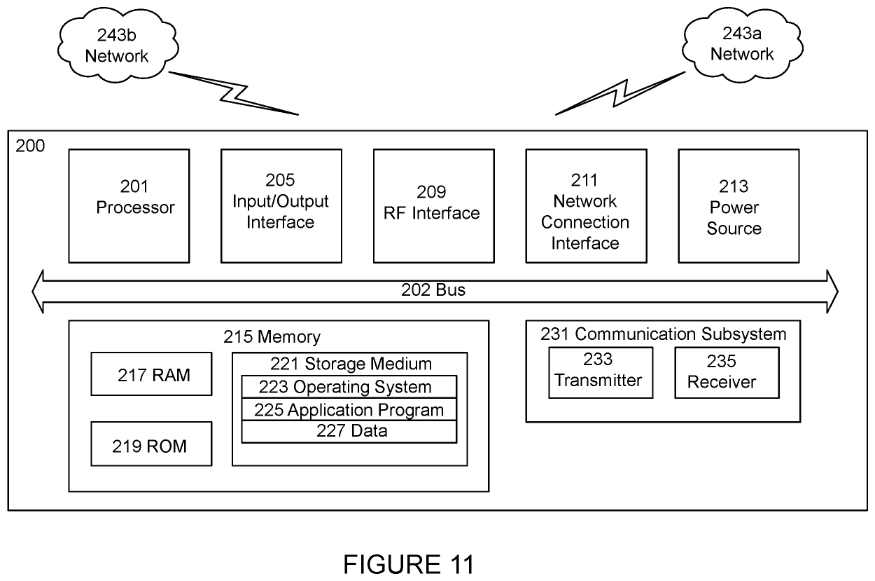

FIG. 11 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 11, is one example of a wireless device configured for communication in accordance with one or more communication standards promulgated by the 3^{rd} Generation Partnership Project (3GPP), such as 3GPP's GSM, UMTS, LTE, and/or 5G standards. As mentioned previously, the term wireless device and UE may be used interchangeable. Accordingly, although FIG. 11 is a UE, the components discussed herein are equally applicable to a wireless device, and vice-versa.

In FIG. 11, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 11, or only a subset of the components. The level of integration between the components may vary from one UE to another UE. Further, certain UEs may contain multiple instances of a component, such as multiple processors, memories, transceivers, transmitters, receivers, etc.

In FIG. 11, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 11, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 11, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another wireless device, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

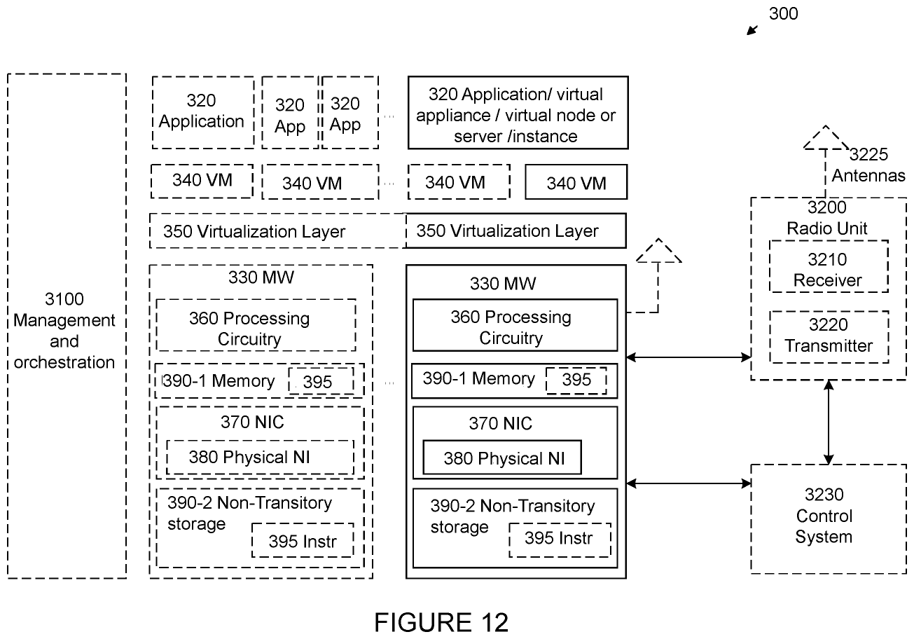

FIG. 12 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 12, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 12.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be affected with the use of control system 3230 which may alternatively be used for communication between the hardware nodes 330 and radio units 3200.

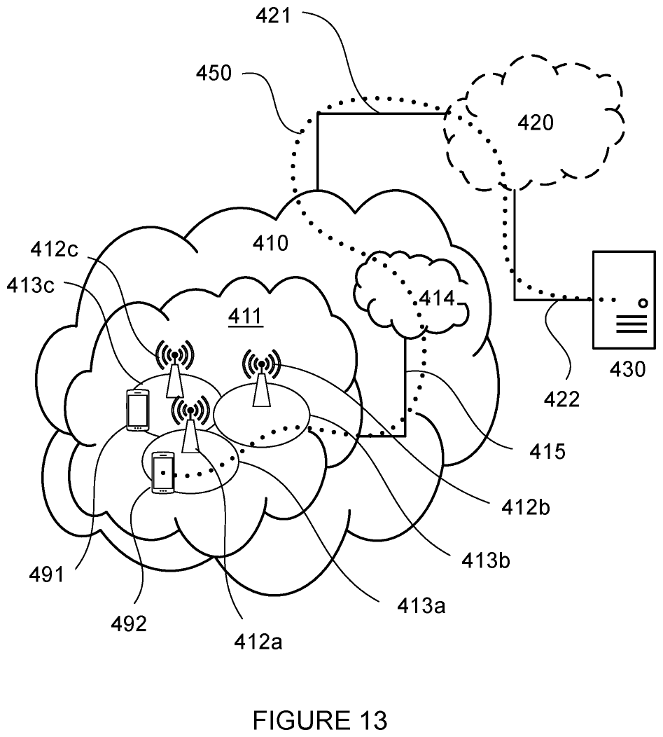

FIG. 13 illustrates a telecommunication network connected via an intermediate network to a host computer in accordance with some embodiments.

With reference to FIG. 13, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 13 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

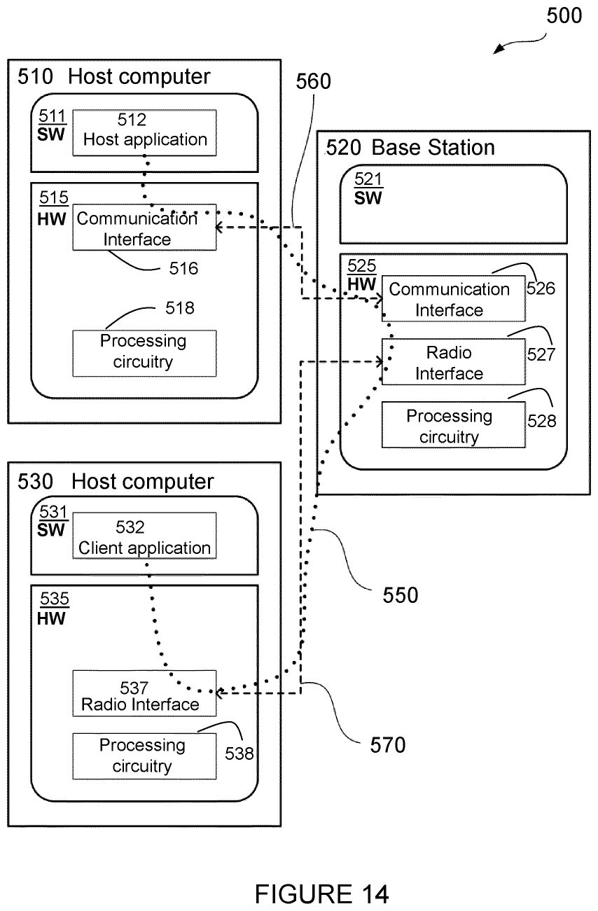

FIG. 14 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 14. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 14) served by base station 520. Communication interface 526 may be configured to facilitate connection 560 to host computer 510. Connection 560 may be direct or it may pass through a core network (not shown in FIG. 14) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 14 may be similar or identical to host computer 430, one of base stations 412a, 412b, 412c and one of UEs 491, 492 of FIG. 13, respectively. This is to say, the inner workings of these entities may be as shown in FIG. 14 and independently, the surrounding network topology may be that of FIG. 13.

In FIG. 14, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

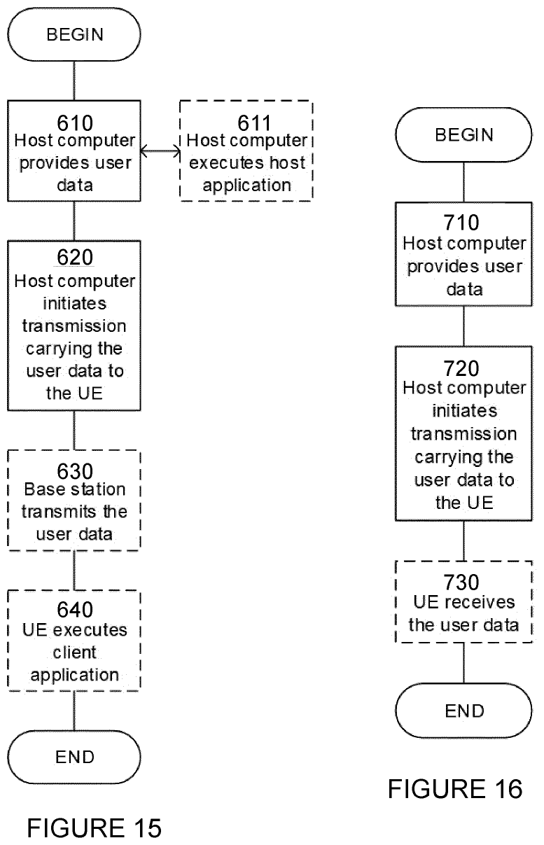

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

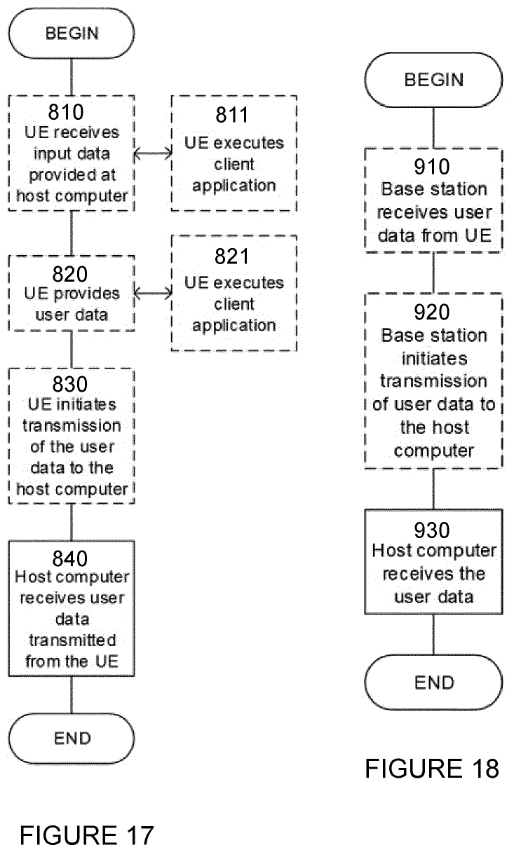

FIG. 17 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 17 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 18 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

FIG. 19 depicts a method 1000 by a wireless device 110, according to certain embodiments. At step 1002, the wireless device 110 receives, from a network node 160, a first PEI, the first PEI being mapped to a first plurality of POs. Based on the first PEI, the wireless device 110 monitors a shared channel during the first plurality of POs, at step 1004.

In various particular embodiments, the method may include one or more of any of the steps or features of the Group A and Group C embodiments described below.

In a particular embodiment, the method 1000 and any one or more of the steps described herein may be performed by processing circuitry 120 or another component of wireless device 110, which is described above in more detail with regard to FIG. 10.

FIG. 20 illustrates a schematic block diagram of a virtual apparatus 1100 in a wireless network (for example, the wireless network shown in FIG. 8). The apparatus may be implemented in a wireless device or network node (e.g., wireless device 110 or network node 160 shown in FIG. 8). Apparatus 1100 is operable to carry out the example method described with reference to FIG. 19 and possibly any other processes or methods disclosed herein. It is also to be understood that the method of FIG. 19 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1110, monitoring module 1120, and any other suitable units of apparatus 1100 to perform corresponding functions according one or more embodiments of the present disclosure.

According to certain embodiments, receiving module 1110 may perform certain of the receiving functions of the apparatus 1100. For example, receiving module 1110 may receive, from a network node, a first paging early indicator (PEI), the first PEI being mapped to a first plurality of paging occasions.

According to certain embodiments, monitoring module 1120 may perform certain of the monitoring functions of the apparatus 1100. For example, based on the first PEI, monitoring module 1120 may monitor a shared channel during the first plurality of paging occasions.

Optionally, in particular embodiments, virtual apparatus may additionally include one or more modules for performing any of the steps or providing any of the features in the Group A and/or Group C embodiments described below.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

FIG. 21 depicts a method 1200 by a wireless device 110, according to certain embodiments. At step 1202, the wireless device 110, which may include a UE such as UE 200, receives, from a network node 160, a PEI configuration that includes an indication of a mapping of a PEI to a plurality of paging occasions. At step 1204, the wireless device 110 receives, from the network node 160, the PEI. Based on the mapping of the PEI to the plurality of POs, the wireless device 110 monitors a shared channel during the plurality of paging occasions.

In a particular embodiment, the wireless device 110 determines, based on the PEI configuration that includes the mapping, that the PEI is mapped to the plurality of POs.

In a particular embodiment, the first plurality of POs comprise a number of consecutive POs.

In a particular embodiment, the PEI is received on a control channel, and the wireless device 110 monitors the control channel during a PEI search window.

In a further particular embodiment, the PEI search window is defined by a offset start and a offset stop, and the wireless device 110 measures the offset start and the offset stop from a first reference point to determine the PEI search window.

In a further particular embodiment, the first reference point comprises a system frame number.

In a further particular embodiment, the PEI search window is determined based on and/or is measured from at least one reference PO.

In a particular embodiment, the PEI configuration is received as DCI, and the DCI includes a bitfield indicating a subset of the plurality of POs that include paging.

In a further particular embodiment, the bitfield comprises a plurality of bits, and each of the plurality of bits indicates a respective one of the plurality of POs.

In a particular embodiment, the bitfield comprises a plurality of bits, and each of the plurality of bits indicates a subset of the plurality of POs.

In a particular embodiment, the wireless device 110 is one of a plurality of wireless devices 110 associated with a group of wireless devices 110, and the DCI includes a bitfield indicating the group of wireless devices 110. Each of the plurality of wireless devices 110 associated with the group of wireless devices 110 is configured to monitor the shared channel during the plurality of POs based on the mapping of the PEI to the plurality of POs.

In a particular embodiment, the PEI configuration is received as SI.

In a particular embodiment, in response to receiving the PEI, the wireless device 110 monitors every n-th paging occasion in a sequence of m paging occasions.

In a particular embodiment, the method 1200 and any one or more of the steps described herein may be performed by processing circuitry 120 or another component of wireless device 110, which is described above in more detail with regard to FIG. 10.

FIG. 22 depicts a method 1300 by a network node 160, according to certain embodiments. At step 1302, the network node 160 maps a first PEI to a first plurality of POs. Based on the mapping, the network node transmits the first PEI to at least one wireless device 110 to triggering monitoring of a shared channel during the first plurality of POs by the at least one wireless device 110, at step 1204.

In various particular embodiments, the method may include one or more of any of the steps or features of the Group B and/or Group C embodiments described below.

In a particular embodiment, the method 1300 and any one or more of the steps described herein may be performed by processing circuitry 170 or another component of network node 160, which is described above in more detail with regard to FIG. 9.

FIG. 23 illustrates a schematic block diagram of a virtual apparatus 1400 in a wireless network (for example, the wireless network shown in FIG. 8). The apparatus may be implemented in a wireless device or network node (e.g., wireless device 110 or network node 160 shown in FIG. 8). Apparatus 1400 is operable to carry out the example method described with reference to FIG. 22 and possibly any other processes or methods disclosed herein. It is also to be understood that the method of FIG. 22 is not necessarily carried out solely by apparatus 1400. At least some operations of the method can be performed by one or more other entities.

Virtual Apparatus 1400 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause mapping module 1410, transmitting module 1420, and any other suitable units of apparatus 1400 to perform corresponding functions according one or more embodiments of the present disclosure.

According to certain embodiments, mapping module 1410 may perform certain of the mapping functions of the apparatus 1400. For example, mapping module 1410 may map a first PEI to a first plurality of POs.

According to certain embodiments, transmitting module 1420 may perform certain of the transmitting functions of the apparatus 1400. For example, based on the mapping, transmitting module 1420 may transmit the first PEI to at least one wireless device 110 to triggering monitoring of a shared channel during the first plurality of POs by the at least one wireless device 110.

Optionally, in particular embodiments, virtual apparatus may additionally include one or more modules for performing any of the steps or providing any of the features in the Group B and/or Group C embodiments described below.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

FIG. 24 depicts another method 1500 by a network node 160, according to certain embodiments. At step 1502, the network node 160 transmits, to at least one wireless device 110, a PEI configuration that includes an indication of a mapping of a first PEI to a plurality of POs. Based on the mapping, the network node 160 transmits the PEI to the at least one wireless device 110 to trigger monitoring of a shared channel during the plurality of POs by the at least one wireless device 110.

In a particular embodiment, the at least one wireless device 110 includes a plurality of wireless devices, and the PEI triggers monitoring of the shared channel by the plurality of wireless devices 110 in the plurality of POs.

In a particular embodiment, the at least one wireless device 110 comprises a first wireless device and a second wireless device. The PEI triggers monitoring of the shared channel by the first wireless device in the plurality of paging occasions, and the PEI triggers monitoring of the shared channel by the second wireless device in the plurality of paging occasions.

In a particular embodiment, the at least one wireless device 110 comprises a first wireless device and a second wireless device, and the plurality of POs comprises a first PO and a second PO. The PEI triggers monitoring of the shared channel by the first wireless device in the first PO, and the PEI triggers monitoring of the shared channel by the second wireless device in the second PO.

In a particular embodiment, the first plurality of POs comprise a number of consecutive POs,

In a particular embodiment, the network node 160 determines the mapping of the PEI to the plurality of POs based on at least one of a performance of a network, a performance of the at least one wireless device 110, network energy efficiency, and user equipment energy efficiency.

In a particular embodiment, the PEI is transmitted on a shared channel, and the network node configures the at least one wireless device 110 to monitor the control channel during a PEI search window.

In a further particular embodiment, the search window is defined by a offset start and a offset stop, and the network node 160 configures the at least one wireless device 110 to measure the offset start and the offset stop from a first reference point.

In a further particular embodiment, the first reference point comprises a system frame number.

In a particular embodiment, the network node 160 configures the at least one wireless device 110 with at least one reference PO, and configuring the at least one wireless device to determine the PEI search window based on the at least one reference PO.

In a particular embodiment, the PEI is transmitted on the shared channel to at least a first wireless device and a second wireless device, and the network node 160 configures the first wireless device to monitor the shared channel during a first PEI search window and the second wireless device to monitor the shared channel during a second PEI search window.

In a further particular embodiment, the first PEI search window is defined by a first offset start and a first offset stop, and the second PEI search window is defined by a second offset start and a second offset stop. The first PEI search window at least partially overlaps with the second PEI search window.

In a further particular embodiment, the first offset start and a first offset stop are measured from a first reference point associated with the first wireless device, and the second offset start and the second offset stop are measured from a second reference point associated with the second wireless device.

In a further particular embodiment, the first reference point comprises a first system frame number and the second reference point comprises a second system frame number.

In a particular embodiment, the PEI configuration is transmitted as DCI, and the DCI includes a bitfield indicating a subset of the plurality of POs that include paging.

In a particular embodiment, the bitfield comprises a plurality of bits, and each of the plurality of bits indicates a respective one of the plurality of POs.

In a further particular embodiment, the bitfield comprises a plurality of bits, and each of the plurality of bits indicates a subset of the plurality of POs.

In a further particular embodiment, the at least one wireless device includes a plurality of wireless devices, and the DCI comprises a bitfield indicating a subset of the plurality of wireless devices, and wherein each wireless device in the subset of wireless devices is configured to monitor the shared channel during the plurality of POs based on the mapping of the PEI to the plurality of paging occasions.

In a particular embodiment, the PEI configuration is transmitted as SI.

In a particular embodiment, the network node 160 determines a number of the plurality of POs to be mapped to the PEI, and the number of the plurality of POs is determined based on at least one of: a traffic measurement; a traffic pattern; an acceptable delay; a number of wireless devices configured with the PEI; an averaging paging rate of each paging occasion in the plurality of paging occasions; and a false paging impact.

In a particular embodiment, the network node 160 configures the at least one wireless device 110 to, in response to receiving the PEI, monitor every n-th paging occasion in a sequence of m paging occasions.

In a particular embodiment, the method 1300 and any one or more of the steps described herein may be performed by processing circuitry 170 or another component of network node 160, which is described above in more detail with regard to FIG. 9.

### EXAMPLE EMBODIMENTS

### Group A Example Embodiments

Example Embodiment A1. A method by a wireless device comprising: receiving, from a network node, a first paging early indicator (PEI), the first PEI being mapped to a first plurality of paging occasions; and based on the first PEI, monitoring a shared channel during the first plurality of paging occasions.

Example Embodiment A2. The method of Example Embodiment A1, further comprising determining that the first PEI is mapped to the plurality of paging occasions.

Example Embodiment A3. The method of any one of Example Embodiments A1 to A2, wherein the first plurality of paging occasions comprise a number of consecutive paging occasions.

Example Embodiment A4. The method of any one of Example Embodiments A1 to A3, further comprising receiving, from the network node, an indication of the mapping of the first PEI to the first plurality of paging occasions.

Example Embodiment A5. The method of Example Embodiment A4, wherein the indication of the mapping is received as a PEI configuration.

Example Embodiment A6. The method of any one of Example Embodiments A1 to A5, wherein the mapping of the first PEI to the first plurality of paging occasions is based on at least one of a performance of a network, a performance of the at least one wireless device, network energy efficiency, and user equipment energy efficiency.

Example Embodiment A7. The method of Example Embodiment A6, further comprising transmitting, to the network node, information associated with at least one of at least one of the performance of the network, the performance of the at least one wireless device, the network energy efficiency, and the user equipment energy efficiency.

Example Embodiment A8. The method of any one of Example Embodiments A1 to A7, wherein the first PEI is received on a control channel

Example Embodiment A9. The method of any one of Example Embodiments A1 to A8, wherein comprises the control channel is monitored during a PEI search window.

Example Embodiment A10. The method of Example Embodiment A9, wherein the PEI search window is defined by a offset start and a offset stop.

Example Embodiment A11. The method of Example Embodiment A10, further comprising measuring the offset start and the offset stop from a first reference point to determine the PEI search window.

Example Embodiment A12. The method of Example Embodiment A11, wherein the first reference point comprises a system frame number.

Example Embodiment A13. The method of Example Embodiment A9, wherein the PEI search window is determined based on and/or is measured from at least one reference paging occasion.

Example Embodiment A14. The method of any one of Example Embodiments A1 to A13, further comprising: receiving a second PEI, the second PEI being mapped to a second plurality of paging occasions; and based on the second PEI, monitoring the shared channel during the second plurality of paging occasions.

Example Embodiment A15. The method of any one of Example Embodiments A1 to A14, wherein the first PEI is received as downlink control information (DCI), and wherein the DCI comprises a bitfield indicating a subset of the first plurality of paging occasions that include paging.

Example Embodiment A16. The method of Example Embodiment A15, wherein the bitfield comprises a plurality of bits, and wherein each of the plurality of bits indicates a respective one of the first plurality of paging occasions.

Example Embodiment A17. The method of Example Embodiment A15, wherein the bitfield comprises a plurality of bits, and wherein each of the plurality of bits indicates a subset of the first plurality of paging occasions.

Example Embodiment A18. The method of Example Embodiment A15, wherein the at least one wireless device is one of a plurality of wireless devices associated with a group of wireless devices, and wherein the DCI comprises a bitfield indicating the group of wireless devices.

Example Embodiment A19. The method of Example Embodiment A15, wherein a number of the first plurality of paging occasions is determined based on at least one of: a traffic measurement; a traffic pattern; an acceptable delay; a number of wireless devices configured with the PEI; an averaging paging rate of each paging occasion in the first plurality of paging occasions; and a false paging impact.

Example Embodiment A20. The method of any one of Example Embodiments A1 to A19, wherein the first plurality of paging occasions are consecutive paging occasions.

Example Embodiment A21. The method of any one of Example Embodiments A1 to A19, wherein the first plurality of paging occasions are pattern-based.

Example Embodiment A22. The method of any one of Example Embodiments A1 to A19, wherein the first plurality of paging occasions are not consecutive paging occasions.

Example Embodiment A23. The method of any one of Example Embodiments A1 to A22, wherein monitoring the first plurality of paging occasions comprises: in response to receiving the first PEI, monitoring every n-th paging occasion in a sequence of m paging occasions.

Example Embodiment A24. The method of any one of Example Embodiments A1 to A23, further comprising receiving paging in the first plurality of paging occasions.

Example Embodiment A25. A wireless device comprising processing circuitry configured to perform any of the methods of Example Embodiments A1 to A24.

Example Embodiment A26. A computer program comprising instructions which when executed on a computer perform any of the methods of Example Embodiments A1 to A24.

Example Embodiment A27. A computer program product comprising computer program, the computer program comprising instructions which when executed on a computer perform any of the methods of Example Embodiments A1 to A24.

Example Embodiment A28. A non-transitory computer readable medium storing instructions which when executed by a computer perform any of the methods of Example Embodiments A1 to A24.

### Group B Embodiments

Example Embodiment B1. A method by a network node comprising: mapping a first paging early indicator (PEI) to a first plurality of paging occasions; and based on the mapping, transmitting the first PEI to at least one wireless device to triggering monitoring of a shared channel during the first plurality of paging occasions by the at least one wireless device.

Example Embodiment B2. The method of Example Embodiment B1, wherein the at least one wireless device comprises a plurality of wireless devices, the first PEI triggering monitoring by the plurality of wireless devices in the first plurality of paging occasions.

Example Embodiment B3. The method of any one of Example Embodiments B1 to B2, wherein: the at least one wireless device comprises a first wireless device and a second wireless device, the first PEI triggers monitoring by the first wireless device in the first plurality of paging occasions, and the first PEI triggers monitoring by the second wireless device in the first plurality of paging occasions.

Example Embodiment B4. The method of any one of Example Embodiments B1 to B2, wherein: the at least one wireless device comprises a first wireless device and a second wireless device, the first plurality of paging occasions comprises a first paging occasion and a second paging occasion, the first PEI triggers monitoring by the first wireless device in the first paging occasion, and the first PEI triggers monitoring by the second wireless device in the second paging occasion.

Example Embodiment B5. The method of any one of Example Embodiments B1 to B4, wherein the first plurality of paging occasions comprise a number of consecutive paging occasions.

Example Embodiment B6. The method of any one of Example Embodiments B1 to B5, further comprising transmitting an indication of the mapping to the at least one wireless device.

Example Embodiment B7. The method of Example Embodiment B6, wherein the indication of the mapping is transmitted as a PEI configuration.

Example Embodiment B8. The method of any one of Example Embodiments B1 to B7, wherein the mapping of the first PEI to the first plurality of paging occasions is determined based on at least one of a performance of a network, a performance of the at least one wireless device, network energy efficiency, and user equipment energy efficiency.

Example Embodiment B9. The method of any one of Example Embodiments B1 to B8, wherein the first PEI is transmitted on a control channel, and the method further comprises configuring the at least one wireless device to monitor the control channel during a PEI search window.

Example Embodiment B10. The method of Example Embodiment B9, wherein the search window is defined by a offset start and a offset stop.

Example Embodiment B11. The method of Example Embodiment B10, further comprising configuring the at least one wireless device to measure the offset start and the offset stop from a first reference point.

Example Embodiment B12. The method of Example Embodiment B11, wherein the first reference point comprises a system frame number.

Example Embodiment B13. The method of Example Embodiment B9, further comprising configuring the at least one wireless device with at least one reference paging occasion, and configuring the wireless to determine the PEI search window based on the at least one reference paging occasion.

Example Embodiment B14. The method of any one of Example Embodiments B1 to B13, further comprising: mapping a second paging early indicator (PEI) to a second plurality of paging occasions; and based on the mapping, transmitting the second PEI to the at least one wireless device to triggering monitoring of a shared channel during the second first plurality of paging occasions by the at least one wireless device.

Example Embodiment B15. The method of any one of Embodiments B1 to B14, wherein the first PEI is transmitted on a control channel to at least a first wireless device and a second wireless device, and wherein the method further comprises: configuring the first wireless device to monitor the control channel during a first PEI search window; and configuring the second wireless device to monitor the control channel during a second PEI search window.

Example Embodiment B16. The method of Example Embodiment B15, wherein: the first PEI search window is defined by a first offset start and a first offset stop, the second PEI search window is defined by a second offset start and a second offset stop, and the first PEI search window at least partially overlaps with the second PEI search window.

Example Embodiment B17. The method of Example Embodiment B16, wherein: the first offset start and a first offset stop are measured from a first reference point associated with the first wireless device, and the second offset start and the second offset stop are measured from a second reference point associated with the second wireless device.

Example Embodiment B18. The method of Example Embodiment B17, wherein the first reference point comprises a first system frame number and the second reference point comprises a second system frame number.

Example Embodiment B19. The method of any one of Example Embodiments B1 to B18, wherein the first PEI is transmitted on a control channel to at least a first wireless device and a second wireless device, and wherein the method further comprises: configuring the first wireless device and the second wireless device to monitor the control channel during a PEI search window.

Example Embodiment B20. The method of Example Embodiment B19, wherein the PEI search window is defined by a offset start and a offset stop.

Example Embodiment B21. The method of Example Embodiment B20, wherein the offset start and a offset stop are measured from a reference point, and the method further comprises configuring the first wireless device and the second wireless device with the reference point.

Example Embodiment B22. The method of Example Embodiment B21, wherein the reference point comprises a system frame number.

Example Embodiment B23. The method of any one of Example Embodiments B1 to B22, wherein the first PEI is transmitted as downlink control information (DCI), and wherein the DCI comprises a bitfield indicating a subset of the first plurality of paging occasions that include paging.

Example Embodiment B24. The method of Example Embodiment B23, wherein the bitfield comprises a plurality of bits, and wherein each of the plurality of bits indicates a respective one of the first plurality of paging occasions.

Example Embodiment B25. The method of Example Embodiment B23, wherein the bitfield comprises a plurality of bits, and wherein each of the plurality of bits indicates a subset of the first plurality of paging occasions.

Example Embodiment B26. The method of any one of Example Embodiments B1 to B22, wherein the at least one wireless device comprises a plurality of wireless devices, and wherein the DCI comprises a bitfield indicating a subset of the plurality of wireless devices.

Example Embodiment B27. The method of any one of Example Embodiments B1 to B26, further comprising determining a number of the first plurality of paging occasions to be mapped to the first PEI.

Example Embodiment B28. The method of Example Embodiment B27, wherein number of the first plurality of paging occasions is determined based on at least one of: a traffic measurement; a traffic pattern; an acceptable delay; a number of wireless devices configured with the PEI; an averaging paging rate of each paging occasion in the first plurality of paging occasions; and a false paging impact.

Example Embodiment B29. The method of any one of Example Embodiments B1 to B28, wherein the first plurality of paging occasions are consecutive paging occasions.

Example Embodiment B30. The method of any one of Example Embodiments B1 to B28, wherein the first plurality of paging occasions are pattern-based.

Example Embodiment B31. The method of any one of Example Embodiments B1 to B28, wherein the first plurality of paging occasions are not consecutive paging occasions.

Example Embodiment B32. The method of any one of Example Embodiments B1 to B28, further comprising configuring the at least one wireless device to, in response to receiving the PEI, monitor every n-th paging occasion in a sequence of m paging occasions.

Example Embodiment B33. The method of any one of Example Embodiments B1 to B32, further comprising transmitting, to the at least one wireless device, paging in the first plurality of paging occasions.

Example Embodiment B34. A network node comprising processing circuitry configured to perform any of the methods of Example Embodiments B1 to B33.

Example Embodiment B35. A computer program comprising instructions which when executed on a computer perform any of the methods of Example Embodiments B1 to B33.

Example Embodiment B36. A computer program product comprising computer program, the computer program comprising instructions which when executed on a computer perform any of the methods of Example Embodiments B1 to B33.

Example Embodiment B37. A non-transitory computer readable medium storing instructions which when executed by a computer perform any of the methods of Example Embodiments B1 to B33.

### Group C Example Embodiments

Example Embodiment C1. A wireless device comprising: processing circuitry configured to perform any of the steps of any of the Group A Example Embodiments; and power supply circuitry configured to supply power to the wireless device.

Example Embodiment C2. A network node comprising: processing circuitry configured to perform any of the steps of any of the Group B Example Embodiments; power supply circuitry configured to supply power to the wireless device.

Example Embodiment C3. A wireless device, the wireless device comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A Example Embodiments; an input interface connected to the processing circuitry and configured to allow input of information into the wireless device to be processed by the processing circuitry; an output interface connected to the processing circuitry and configured to output information from the wireless device that has been processed by the processing circuitry; and a battery connected to the processing circuitry and configured to supply power to the wireless device.

Example Embodiment C4. A communication system including a host computer comprising: processing circuitry configured to provide user data; and a communication interface configured to forward the user data to a cellular network for transmission to a wireless device, wherein the cellular network comprises a network node having a radio interface and processing circuitry, the network node's processing circuitry configured to perform any of the steps of any of the Group B Example Embodiments.

Example Embodiment C5. The communication system of the pervious embodiment further including the network node.

Example Embodiment C6. The communication system of the previous 2 embodiments, further including the wireless device, wherein the wireless device is configured to communicate with the network node.

Example Embodiment C7. The communication system of the previous 3 embodiments, wherein: the processing circuitry of the host computer is configured to execute a host application, thereby providing the user data; and the wireless device comprises processing circuitry configured to execute a client application associated with the host application.

Example Embodiment C8. A method implemented in a communication system including a host computer, a network node and a wireless device, the method comprising: at the host computer, providing user data; and at the host computer, initiating a transmission carrying the user data to the wireless device via a cellular network comprising the network node, wherein the network node performs any of the steps of any of the Group B Example Embodiments.

Example Embodiment C9. The method of the previous embodiment, further comprising, at the network node, transmitting the user data.

Example Embodiment C10. The method of the previous 2 embodiments, wherein the user data is provided at the host computer by executing a host application, the method further comprising, at the wireless device, executing a client application associated with the host application.

Example Embodiment C11. A wireless device configured to communicate with a network node, the wireless device comprising a radio interface and processing circuitry configured to performs the of the previous 3 embodiments.

Example Embodiment C12. A communication system including a host computer comprising: processing circuitry configured to provide user data; and a communication interface configured to forward user data to a cellular network for transmission to a wireless device, wherein the wireless device comprises a radio interface and processing circuitry, the wireless device's components configured to perform any of the steps of any of the Group A Example Embodiments.

Example Embodiment C13. The communication system of the previous embodiment, wherein the cellular network further includes a network node configured to communicate with the wireless device.

Example Embodiment C14. The communication system of the previous 2 embodiments, wherein: the processing circuitry of the host computer is configured to execute a host application, thereby providing the user data; and the wireless device's processing circuitry is configured to execute a client application associated with the host application.

Example Embodiment C15. A method implemented in a communication system including a host computer, a network node and a wireless device, the method comprising: at the host computer, providing user data; and at the host computer, initiating a transmission carrying the user data to the wireless device via a cellular network comprising the network node, wherein the wireless device performs any of the steps of any of the Group A Example Embodiments.

Example Embodiment C16. The method of the previous embodiment, further comprising at the wireless device, receiving the user data from the network node.

Example Embodiment C17. A communication system including a host computer comprising: communication interface configured to receive user data originating from a transmission from a wireless device to a network node, wherein the wireless device comprises a radio interface and processing circuitry, the wireless device's processing circuitry configured to perform any of the steps of any of the Group A Example Embodiments.

Example Embodiment C18. The communication system of the previous embodiment, further including the wireless device.

Example Embodiment C19. The communication system of the previous 2 embodiments, further including the network node, wherein the network node comprises a radio interface configured to communicate with the wireless device and a communication interface configured to forward to the host computer the user data carried by a transmission from the wireless device to the network node.

Example Embodiment C20. The communication system of the previous 3 embodiments, wherein: the processing circuitry of the host computer is configured to execute a host application; and the wireless device's processing circuitry is configured to execute a client application associated with the host application, thereby providing the user data.

Example Embodiment C21. The communication system of the previous 4 embodiments, wherein: the processing circuitry of the host computer is configured to execute a host application, thereby providing request data; and the wireless device's processing circuitry is configured to execute a client application associated with the host application, thereby providing the user data in response to the request data.

Example Embodiment C22. A method implemented in a communication system including a host computer, a network node and a wireless device, the method comprising: at the host computer, receiving user data transmitted to the network node from the wireless device, wherein the wireless device performs any of the steps of any of the Group A Example Embodiments.

Example Embodiment C23. The method of the previous embodiment, further comprising, at the wireless device, providing the user data to the network node.

Example Embodiment C24. The method of the previous 2 embodiments, further comprising: at the wireless device, executing a client application, thereby providing the user data to be transmitted; and at the host computer, executing a host application associated with the client application.

Example Embodiment C25. The method of the previous 3 embodiments, further comprising: at the wireless device, executing a client application; and at the wireless device, receiving input data to the client application, the input data being provided at the host computer by executing a host application associated with the client application, wherein the user data to be transmitted is provided by the client application in response to the input data.

Example Embodiment C26. A communication system including a host computer comprising a communication interface configured to receive user data originating from a transmission from a wireless device to a network node, wherein the network node comprises a radio interface and processing circuitry, the network node's processing circuitry configured to perform any of the steps of any of the Group B Example Embodiments.

Example Embodiment C27. The communication system of the previous embodiment further including the network node.

Example Embodiment C28. The communication system of the previous 2 embodiments, further including the wireless device, wherein the wireless device is configured to communicate with the network node.

Example Embodiment C29. The communication system of the previous 3 embodiments, wherein: the processing circuitry of the host computer is configured to execute a host application; the wireless device is configured to execute a client application associated with the host application, thereby providing the user data to be received by the host computer.

Example Embodiment C30. A method implemented in a communication system including a host computer, a network node and a wireless device, the method comprising: at the host computer, receiving, from the base station, user data originating from a transmission which the network node has received from the wireless device, wherein the wireless device performs any of the steps of any of the Group A Example Embodiments.

Example Embodiment C31. The method of the previous embodiment, further comprising at the network node receiving the user data from the wireless device.

Example Embodiment C32. The method of the previous 2 embodiments, further comprising at the network node, initiating a transmission of the received user data to the host computer.

Example Embodiment C33. The method of any of the previous embodiments, wherein the network node comprises a base station.

Example Embodiment C34. The method of any of the previous embodiments, wherein the wireless device comprises a user equipment (UE).

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1.-38. (canceled)

39. A method by a wireless device comprising:
receiving, from a network node, a paging early indicator, PEI, configuration comprising an indication of a mapping of a PEI to a plurality of paging occasions;
receiving, from the network node, the PEI; and
based on the mapping of the PEI to the plurality of paging occasions, monitoring a shared channel for paging in one of the plurality of paging occasions if the received PEI indicates that the paging is intended for the UE.

40. The method of claim 39, further comprising determining, based on the PEI configuration comprising the indication of the mapping, that the PEI is mapped to the plurality of paging occasions.

41. The method of claim 39, wherein the first plurality of paging occasions comprise a number of consecutive paging occasions.

42. The method of claim 39, wherein the PEI is received on a control channel, and the method further comprises monitoring the control channel during a PEI search window.

43. The method of claim 42, wherein the PEI search window is defined by a offset start and a offset stop, and the method further comprises measuring the offset start and the offset stop from a first reference point to determine the PEI search window.

44. The method of claim 43, wherein the PEI search window is determined based on and/or is measured from at least one reference paging occasion.

45. The method of claim 39, wherein the PEI configuration is received as system information, SI.

46. The method of claim 39, further comprising, in response to receiving the PEI, monitoring every n-th paging occasion in a sequence of m paging occasions.

47. A method by a network node comprising:
transmitting, to at least one wireless device, a paging early indicator, PEI, configuration comprising an indication of a mapping of a first PEI to a plurality of paging occasions; and
based on the mapping, transmitting the PEI to the at least one wireless device to trigger monitoring of a shared channel for paging in one of the plurality of paging occasions by the at least one wireless device, wherein the paging is intended for the at least one wireless device.

48. The method of claim 47, wherein the at least one wireless device comprises a plurality of wireless devices, the PEI triggering monitoring of the shared channel by the plurality of wireless devices in the plurality of paging occasions.

49. The method of claim 48, wherein:
the at least one wireless device comprises a first wireless device and a second wireless device,
the PEI triggers monitoring of the shared channel by the first wireless device in the plurality of paging occasions, and
the PEI triggers monitoring of the shared channel by the second wireless device in the plurality of paging occasions.

50. The method of claim 49, wherein:
the at least one wireless device comprises a first wireless device and a second wireless device,
the plurality of paging occasions comprises a first paging occasion and a second paging occasion,
the PEI triggers monitoring of the shared channel by the first wireless device in the first paging occasion, and
the PEI triggers monitoring of the shared channel by the second wireless device in the second paging occasion.

51. The method of claim 47, wherein the first plurality of paging occasions comprise a number of consecutive paging occasions.

52. The method of claim 47, further comprising determining the mapping of the PEI to the plurality of paging occasions based on at least one of a performance of a network, a performance of the at least one wireless device, network energy efficiency, and user equipment energy efficiency.

53. The method of claim 47, wherein the PEI is transmitted on a shared channel, and the method further comprises configuring the at least one wireless device to monitor the control channel during a PEI search window.

54. The method of claim 15, wherein the search window is defined by a offset start and a offset stop, and wherein the method further comprises configuring the at least one wireless device to measure the offset start and the offset stop from a first reference point.

55. The method of claim 53, further comprising configuring the at least one wireless device with at least one reference paging occasion, and configuring the at least one wireless device to determine the PEI search window based on the at least one reference paging occasion.

56. The method of claim 47, wherein the PEI is transmitted on the shared channel to at least a first wireless device and a second wireless device, and wherein the method further comprises:
configuring the first wireless device to monitor the shared channel during a first PEI search window; and
configuring the second wireless device to monitor the shared channel during a second PEI search window.

57. The method of claim 56, wherein:
the first PEI search window is defined by a first offset start and a first offset stop,
the second PEI search window is defined by a second offset start and a second offset stop, and
the first PEI search window at least partially overlaps with the second PEI search window.

58. The method of claim 57, wherein:
the first offset start and a first offset stop are measured from a first reference point associated with the first wireless device, and
the second offset start and the second offset stop are measured from a second reference point associated with the second wireless device.

59. The method of claim 47, wherein the PEI configuration is transmitted as system information, SI.

60. The method of claim 47, further comprising configuring the at least one wireless device to, in response to receiving the PEI, monitor every n-th paging occasion in a sequence of m paging occasions.

61. A wireless device comprising:
a memory storing instructions; and
a processor operable to execute the instructions to cause the wireless device to:
receive (1202), from a network node, a paging early indicator, PEI, configuration comprising an indication of a mapping of a PEI to a plurality of paging occasions;
receive (1204), from the network node, the PEI; and
based on the mapping of the PEI to the plurality of paging occasions, monitor (1206) a shared channel for paging in one of the plurality of paging occasions if the received PEI indicates that the paging is intended for the UE.

62. The wireless device of claim 61, wherein the processor is operable to execute the instructions to cause the wireless device to determine, based on the PEI configuration comprising the indication of the mapping, that the PEI is mapped to the plurality of paging occasions.

63. A network node comprising:
a memory storing instructions; and
a processor operable to execute the instructions to cause the network node to:
transmit, to at least one wireless device, a paging early indicator, PEI, configuration comprising an indication of a mapping of a first PEI to a plurality of paging occasions; and
based on the mapping, transmit the PEI to the at least one wireless device to trigger monitoring of a shared channel for paging in one of the plurality of paging occasions by the at least one wireless device, wherein the paging is intended for the at least one wireless device.

64. The network node of claim 63, wherein the at least one wireless device comprises a plurality of wireless devices, the PEI triggering monitoring of the shared channel by the plurality of wireless devices in the plurality of paging occasions.
